(19) United States
(12) Patent Application Publication
(10) Pub. No.: US 2021/0075263 A1
(43) Pub. Date: Mar. 11, 2021

(54) REDUCING MAGNETIC FIELD VARIATION IN A CHARGING DEVICE

(71) Applicant: Intel Corporation, Santa Clara, CA (US)

(72) Inventors: Songnan Yang, San Jose, CA (US); Bin Xiao, San Ramon, CA (US); Janardhan Koratikere Narayan, Fremont, CA (US); Sreenivas Kasturi, Hillsboro, OR (US); Essam Elkhouly, San Jose, CA (US)

(21) Appl. No.: 16/997,269

(22) Filed: Aug. 19, 2020

Related U.S. Application Data
(63) Continuation of application No. 16/211,938, filed on Dec. 6, 2018, now abandoned.
Application No. 16/211,938 is a continuation of application No. 14/319,802, filed on Jun. 30, 2014, now abandoned.
(60) Provisional application No. 61/981,595, filed on Apr. 18, 2014.

(51) Int. Cl. H02J 50/12; H02J 50/40; H01F 27/28; H01F 38/14; H01F 41/071

(52) U.S. Cl. CPC H02J 50/12; H02J 50/40; H01F 41/071; H01F 38/14; H01F 27/2823

(57) ABSTRACT

Systems and methods may provide for a wireless charging device having a concave-shaped charging platform defining a charging area. The wireless charging device may include a three-dimensional transmitter coil, and at least one additional transmitter coil having a non-uniform spacing within the concave-shaped charging platform to reduce magnetic field variations associated with the three-dimensional transmitter coil.

### CROSS REFERENCE TO RELATED APPLICATIONS

The present application is a continuation application of U.S. Non-provisional application Ser. No. 16/211,938, filed Dec. 6, 2018, which is a continuation application of U.S. Non-Provisional application Ser. No. 14/319,802, filed Jun. 30, 2014, which claims priority to U.S. Provisional Patent Application No. 61/981,595, filed Apr. 18, 2014, each of which are incorporated herein by reference in their entireties.

### TECHNICAL FIELD

Aspects described herein generally relate to a wireless charging device. More particularly, aspects described herein relate to a wireless charging device having a charging station with concave cross-section and a transmitting coil having spacing to reduce magnetic field variation.

### BACKGROUND

An electronic device powered by an internal rechargeable battery, generally requires recharging of the battery. Current wireless charging platforms generally have charging device with a charging pad having a generally flat, planar charging surface and a transmitter which sends a charging signal received by a receiver arranged in the electronic device. Use of such a charging pad, however, requires orienting the electronic device in close spatial proximity at a specific location on the pad such that its power receiver is properly operationally aligned with the power transmitter of the charging pad.

### BRIEF DESCRIPTION OF THE DRAWINGS

The various advantages of the aspects will become apparent to one skilled in the art by reading the following specification and appended claims, and by referencing the following drawings, in which:

FIG. 1 is a front perspective view of an example of a wireless charging device, in accordance with aspects;

FIGS. 2A, 2B, and 2C each illustrates diagrams of particular variables in magnetic field distribution;

FIG. 3 is a cross-sectional diagram view of the wireless charging device having a concave shape;

FIG. 4 is a diagram of a curve of the wireless charging device;

FIG. 5 is a graph illustrating a distribution of the magnetic field of the wireless charging device;

FIG. 6 is a perspective view of a three-dimensional transmitter coil arranged about a bowl;

FIG. 7 is a diagram of a curve of the wireless charging device having coils as well as a parasitic coil; and

FIG. 8 is a perspective view of the wireless charging device having coils as well as the parasitic coil.

FIG. 9 is a block diagram illustrating a method of forming a wireless charging device.

### DESCRIPTION OF ASPECTS

Techniques described herein relate to an example of a wireless charging device. The wireless charging device may include a concave-shaped charging platform defining a charging area. At least one transmitter coil is arranged about the platform. The three-dimensional transmitter coil may include a coil turn to carry alternating electrical current At least one additional turn to carry alternating electrical current may also be included. As described in more detail below, the coil turns are spaced at a non-uniform spacing to reduce magnetic field variations associated with the three-dimensional transmitter coil.

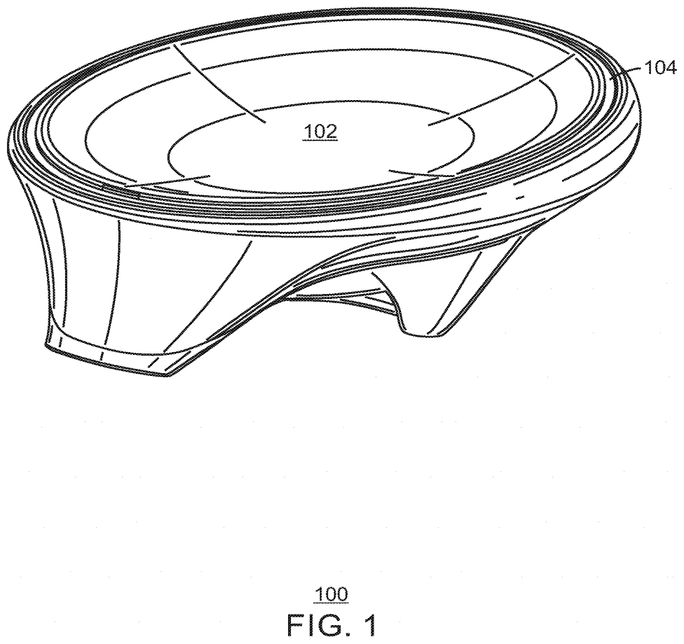

FIG. 1 is a front perspective view of an example of a wireless charging device, in accordance with aspects. The wireless charging device 100 is configured to charge an internally-arranged rechargeable battery of one or more electronic devices (not shown) that are supported in a charging area 102 defined by a semi-hemispherical or bowl-shaped charging station 104. The semi-hemispherical or bowl-shaped charging station 104 may simultaneously charge one or more electronic devices placed in the charging area 102, regardless of their respective location and spatial orientation relative to the wireless charging device 100. The devices may vary in size and type, and may have the same or different functions, such as, for example, a convertible tablet, an electronic book (ebook) reader a smart phone, a smart watch, or a smart wearable device. The illustrated charging station 104 generally represents a universal wireless charging solution in that it accepts devices having different functions and/or manufacturers and does not require devices to be plugged into or otherwise connected to the charging station 104 in order for them to be charged. As will be discussed in greater detail, the charging station 104 may use electromagnetic energy to charge the battery of each respective electronic device. While not illustrated in FIG. 1, the charging station 104 may include a transmission coil having non-uniform spacing between turns of the transmission coil. The non-uniform spacing may enable a relatively even distribution of a magnetic field associated with the transmission coil when an electric current flows through the transmission coil. The even distribution of the magnetic field may provide relatively consistent charging when compared to a transmission coil having uniform spacing between the coils.

Magnetic resonance wireless charging (such as defined in the A4WP standard) employs magnetic coupling between a resonant transmit (TX) coil and a resonant receive (RX) coils to achieve power transfer. A common issue seen in these types of wireless charging systems is the non-uniform nature of power delivered to the RX coil as it is moved within the charging area. This issue is caused by the inherent non-uniform magnetic field distribution generated by TX coils, which is especially pronounced when the TX and RX coils of wireless power transfer system are very close to each other (such as the configuration of a device charged on the surface of a bowl). In the “z” direction, extending perpendicular to the coil turn, the magnetic field uniformity is a factor in an H_{z} component of the magnetic field. In the “R” direction, extending outward from a center point of the coil, the magnetic field uniformity is a factor in an Hᵣ component of the magnetic field. These factors can be described as follows in Equation 1 and Equation 2:

$$\begin{matrix}{H}_{z} ( R , ϕ , z ) = \frac{{I}_{0}}{2 π \sqrt{{( r + a )}^{2} + {z}^{2}}} \cdot [ K ( {k}_{c} ) - \frac{{R}^{2} - {a}^{2} + {z}^{2}}{{( R - a )}^{2} + {z}^{2}} E ( {k}_{c} ) ] & Eq . 1 \\ {H}_{R} ( R , ϕ , z ) = \frac{{zI}_{0}}{2 π \sqrt{{( R + a )}^{2} + {z}^{2}}} \cdot [ - K ( {k}_{c} ) - \frac{{R}^{2} + {a}^{2} + {z}^{2}}{{( R - a )}^{2} + {z}^{2}} E ( {k}_{c} ) ] . & Eq . 2\end{matrix}$$

In Eq. 1 and Eq. 2, K(k) and E(k) are the complete elliptic integral functions of the first and the second kind, and

$${k}_{c}^{2} = \frac{4 aR}{} .$$

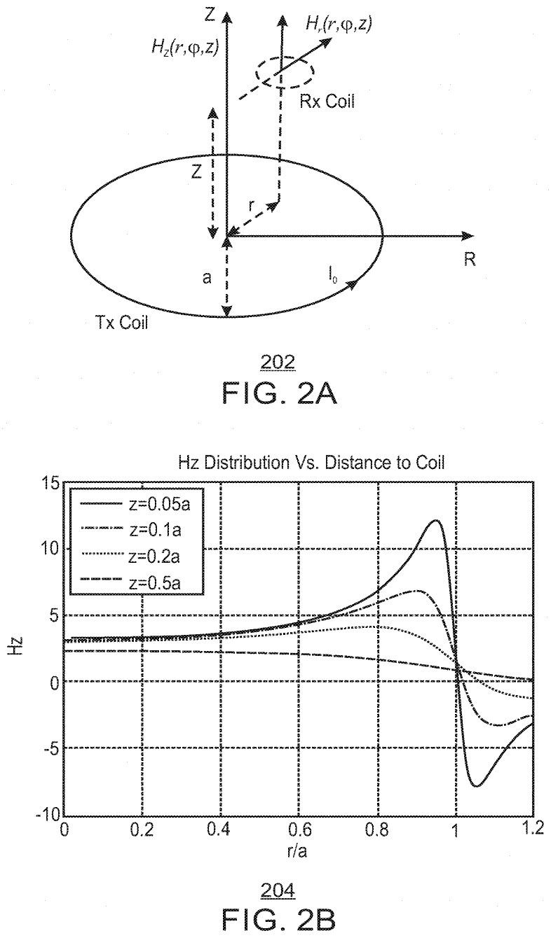

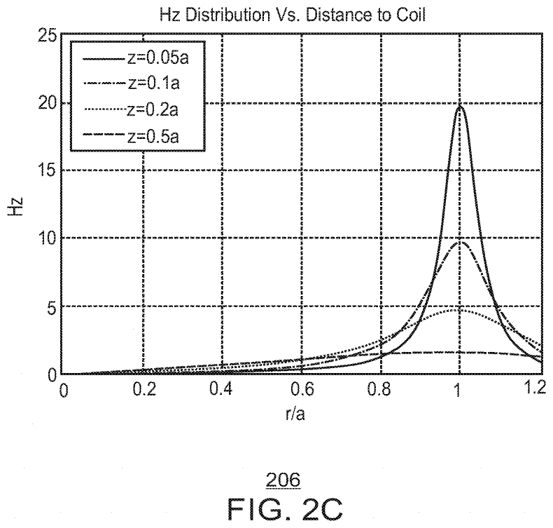

FIGS. 2A, 2B, and 2C each illustrates diagrams of particular variables in magnetic field distribution. At 202, the z direction magnetic field (H_{z}) generated by a single loop (cylindrical coordinates) is illustrated, at 204, the H_{z} distribution at various vertical separations (z) is illustrated, and at 206, the H_{z} distribution at various vertical separations (R) is illustrated. At 204 the distribution of z direction magnetic field (H_{z}) generated by a single loop at different elevation (z) is illustrated. Conventionally, the three-dimensional Tx coil can be designed to have multiple turns with non-uniform spacing such that the combined z direction magnetic field can be optimized on a surface at a fixed distance away from the coil. For a curved surface, especially for charging small wearable devices, the normal direction of the magnetic field II at certain distance away from the surface has to be optimized for uniformity across the curved surface, which significantly complicates the problem by introducing the R direction component generated by the three-dimensional Tx coil at different elevations, the composition of normal component also changes as the surface curves.

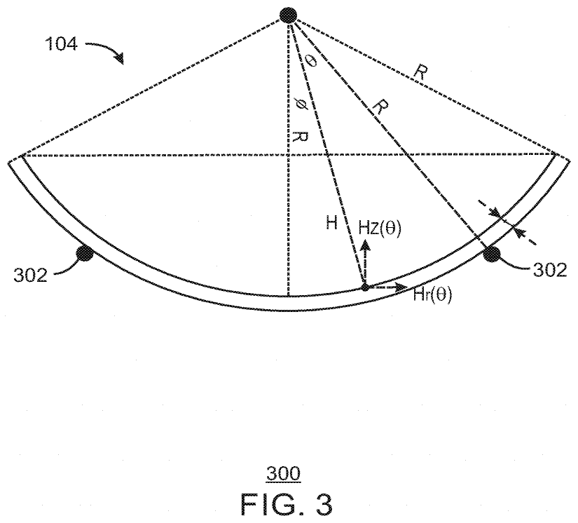

FIG. 3 is a cross-sectional diagram view of the wireless charging device having a concave shape. As illustrated in FIG. 3, the cross section view 300 of a bowl shaped wireless charging transmitter, such as the bowl-shaped charging station 104 of FIG. 1, is depicted. The bowl-shaped charging station 104 may have a curved surface radius “R,” and single coil turn 302 located at angular position “θ,” as illustrated in FIG. 3. The thickness of bowl-shaped charging station 104 is “t.” Based on the closed form expressions described above, the combined normal direction magnetic field “H_{↑}” at inner surface location with angular position “φ” can be expressed in Equation 3, Equation 4, and Equation 5:

H_{↑}(θ,φ)=H_{z}(θ,φ)·cos φ−Hᵣ(θ,φ)·sin φ Eq. 3

H_{z}(θ,φ)=H_{z}(x(θ,φ),z(θ,φ))=H_{z}((R−t)·sin φ,R·cos θ−(R−t)·cos φ) Eq. 4

Hᵣ(θ,φ)=Hᵣ(x(θ,φ),z(θ,φ))=Hᵣ((R−t)·sin φ,R·cos θ−(R−t)·cos φ) Eq. 5

The corresponding radius of the coil can be represented by R*sin θ.

With this closed form expression of Eqs. 3-5, a combination of multiple turns of the coil arranged at different angular locations along the curve of the bowl-shaped charging station 104 may be calculated. Further, the location and current distribution of current among turns for minimum variation of the normal magnetic field within a given area of the bowl surface may be optimized for minimum magnetic field variation.

Following the formulation, the coil design with multiple connected turns is carried out by optimization for minimum combined surface normal H field variation. According to the derivation in Eq. 1 and Eq. 2, the total normal field along inner surface of the bowl can be described by Equation 6:

$${H}_{↑ total} ( ϕ ) = {\sum }_{i = 1}^{n} ( {H}_{z} ( {θ}_{i} , ϕ ) \cdot cos ϕ - {H}_{r} ( {θ}_{i} , ϕ ) \cdot sin ϕ ) \qquad Eq . 6$$

The optimization process starts by initial population of turns at various angles [θ₁, θ₂, θ₃ . . . θₙ]. Then, the [symbol] ₜₒₜₐₗ of such combination is calculated along the inner surface of the bowl (varying ϕ), and the variance of [symbol] ₜₒₜₐₗ is calculated as a cost function of the optimization. A new population of coil location combinations is generated for evaluation. A genetic algorithm may be used to repeat the process until the result of the cost function is minimized, or ceases to decrease. In aspects, a genetic algorithm may be is a search heuristic that mimics the process of natural selection. In some aspects, the genetic algorithm may be used to repeat the process until a predefined threshold is met defined by a change in the cost function being less than a certain threshold.

The optimization variables are the coil turns angular locations θ=[θ¹, θ², θ³ . . . θₙ]. To form the optimization problem, there are constraints for each optimization variables should be defined. For example in this particular design the largest angular offset is 60 degrees, so all coils are bounded by this size. In addition, for each inner turn its dimensions should not exceed the dimensions of the next greater loop and there should be a spacing of t (in this example 5 mm) to leave a space for the trace width and the gap (e.g. θₜ>θₜ₊₁+3°).

The optimization problem is defined by Equation 7 and Equation 8:

arg_{θ} min (Var(Hₜₒₜₐₗ(φ))), subject to: 0<θ<60° Eq. 7

(θₜ)>(θₜ₋₁)+3° Eq. 8

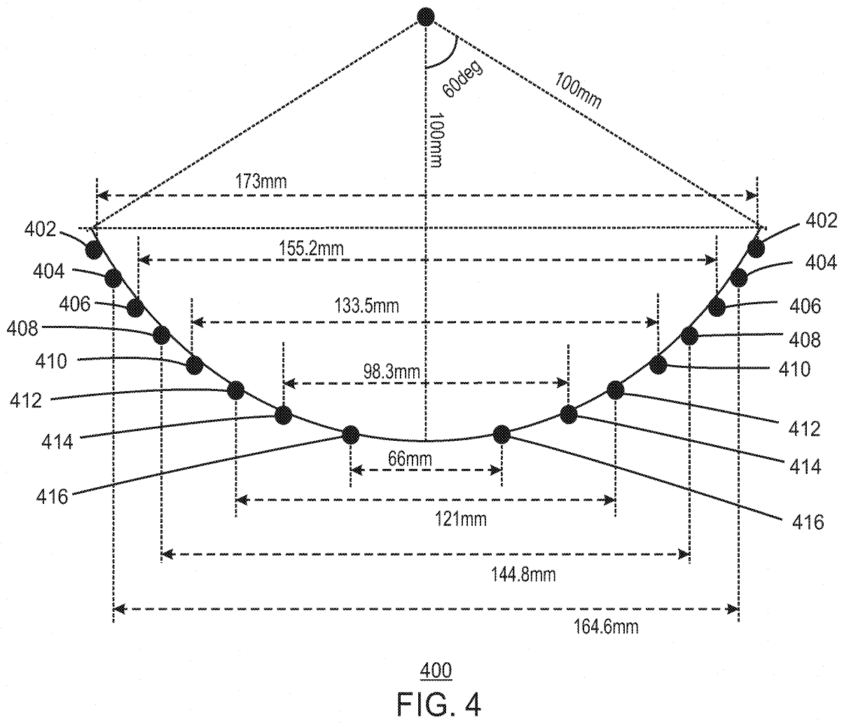

FIG. 4 is a diagram of a curve of the wireless charging device. The coil design described herein may include a continuous three-dimensional spiral structure 400. The coil may be composed of a 14AWG wire to minimize the trace resistance. In this example, a minimum spacing between turns may be 5 millimeters (mm) (3 degrees angular spacing) to minimize inter-turn capacitance.

In the example illustrated in FIG. 4, the three-dimensional Tx coil has a 10 cm radius bowl with 120 degree span. A non-uniform distribution of coil radii and spacing is achieved through optimization to offer maximum surface normal H field uniformity.

The three-dimensional spiral structure 400 may include eight circular coil turns that are coaxial. For example, the coil turns may include a first coil turn 402 of the three-dimensional transmitter coil having a diameter of about 173 mm, and a second coil turn 404 coupled to the first coil turn 402 having a diameter of about 164.6 mm. A third could turn 406 may be coupled to the second coil turn 404 and may have a diameter of about 155.2 mm. A fourth coil turn 408 may be coupled to the third coil turn 406, and may have a diameter of about 144.8 mm. A fifth coil turn 410 may be coupled to the fourth coil turn 408, and may have a diameter of about 133.5. A sixth coil turn 412 may be coupled to the fifth coil turn 410, and may have a diameter of about 121 mm. A seventh coil turn 414 may be coupled to the sixth coil turn 412, and may have a diameter of about 98.3 mm. An eight coil turn 416 may be coupled to the seventh coil turn 412, and may have a diameter of about 66 mm.

In FIG. 4, the specific dimensions are not limiting to the aspects described herein. Other dimensions may be used based the on the optimization process described above.

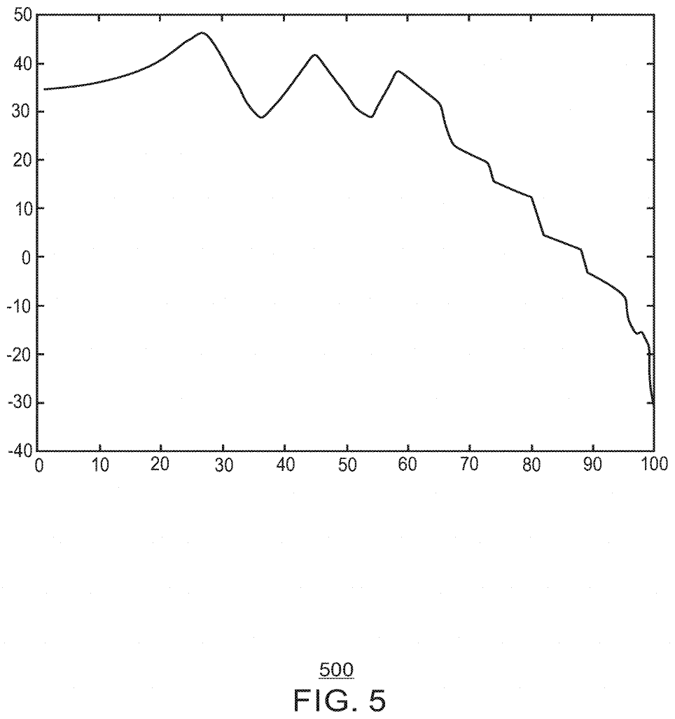

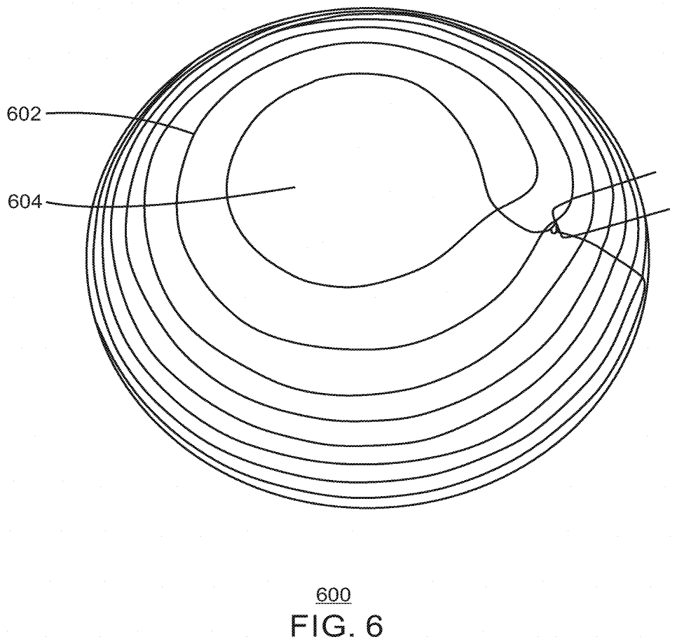

FIG. 5 is a graph illustrating a distribution of the magnetic field of the wireless charging device. In the graph 500, the horizontal axis is a distance from the center of a three-dimensional spiral structure, such as the three-dimensional spiral structure 400 discussed above in regard to FIG. 4. The vertical axis represents the combined normal H field. As illustrated in FIG. 5 up to 60-70% of the angular offset (i.e. up to 40 degrees or so) the field is fairly uniform to support charging of devices.

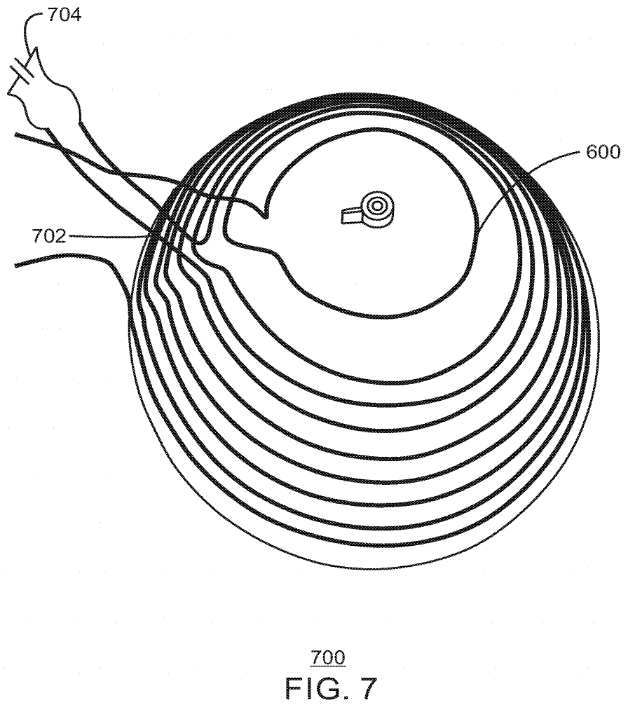

FIG. 6 is a perspective view of a three-dimensional transmitter coil arranged about a bowl. The three-dimensional TX coil 600 may have spacing as indicated in the three-dimensional spiral structure 400 discussed above in regard to FIG. 4. The three-dimensional TX coil 600 may, in some scenarios, by a continuous copper wire, as indicated at 602 arranged about the outer surface of a bowl 604. In FIG. 6, the design may be optimized assuming that each turn of the three-dimensional TX coil 600 is connected in series and carries the similar current.

FIG. 7 is a diagram of a curve of the wireless charging device having coils as well as a parasitic coil. In some aspects, to further improve the coupling with receiver devices and improve the field uniformity, at least one parasitic coil 702 may be implemented. The parasitic coil 702 is a coil turn disposed between other coil turns of a three-dimensional TX coil, such as the three-dimensional TX coil 600 discussed above in regard to FIG. 6. The parasitic coil 702 may be tuned, and may be configured to carry non-unit current to be introduced at strategic locations. The non-unit current carried by the parasitic coil 702 may redistribute magnetic fields associated with the three-dimensional TX coil 600 by propagating a current in an opposite direction in relationship to the current propagating on the three-dimensional TX coil 600. As shown in FIG. 7, the parasitic coil 702 may be tuned by a series capacitor 704 based on a desired magnetic field variation.

The design with one or more parasitic coils, such as the parasitic coil 702 may be optimized by introducing non-uniform current distribution arguments between turns of the coil, where the normal H field can be expressed as:

$${H}_{↑ total} ( ϕ ) = {\sum }_{i = 1}^{n} {a}_{i} ( {H}_{z} ( {θ}_{i} , ϕ ) \cdot cos ϕ - {H}_{r} ( {θ}_{i} , ϕ ) \cdot sin ϕ ) \qquad Eq . 10$$

Where a=[a₁, a₂, a₃ . . . aₙ] describes the current ratio between multiple turns of the coil. The optimization process will optimize both a and θ to achieve a desired magnetic field distribution in terms of uniformity and coupling capacity. After the current ratio is defined, the series capacitor 704 can be tuned to achieve the current ratio.

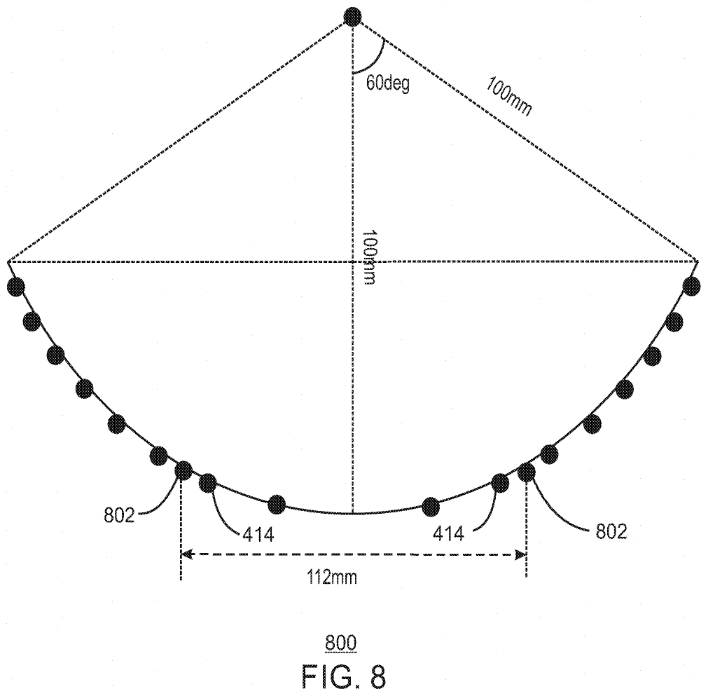

FIG. 8 is a perspective view of the wireless charging device having coils as well as the parasitic coil. As illustrated in FIG. 8, a parasitic coil, such as the parasitic coil 802, may have a diameter of about 112 mm. The parasitic coil 802 is configured to redistribute the magnetic field associated with a turn, such as the turn 414 discussed above in regard to FIG. 4.

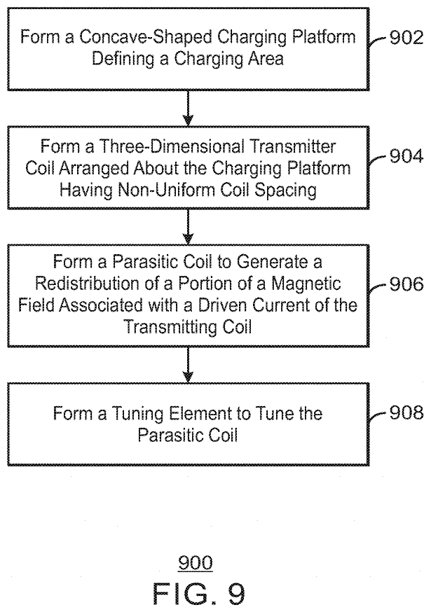

FIG. 9 is a block diagram illustrating a method of forming a wireless charging device. The method 900 includes forming a concave-shaped charging platform defining a charging area at block 902. At block 904, the method 900 includes forming a three-dimensional transmitter coil arranged about the charging platform. The three-dimensional transmitter coil includes a turn configured to conduct an electric current and additional turns configured to conduct the electric current A spacing between the turns is non-uniform such that a magnetic field variation may be relatively even in comparison to coil turns having a uniform spacing between the coil turns.

In some aspects, the method 900 may include forming a parasitic coil at block 906. The parasitic coil may be formed between at least two of the turns of the transmitter coil. The parasitic coil may be configured to generate a redistribution of a portion of a magnetic field associated with a driven current of the transmitting coil. At block 908, a tuning element may be formed. The tuning element includes a capacitor. The redistribution of the magnetic field may be configurable based on a capacitance of the tuning element. For example, a lower capacitance of the tuning element may generate a larger redistribution of the magnetic field in comparison to a higher capacitance of the tuning element.

In some aspects, the method 900 may include optimization of three-dimensional transmitter coil spacing. For example, the method 900 may include identifying a coil structure having initially having arbitrary angles of each coil turn from an axis extending through a center of a coil, and determining a magnetic field variation of the coil structure. The angles may be adjusted based on results of a cost function indicating uniformity of the magnetic field.

Example 1 is a wireless charging device. The wireless charging device includes a three-dimensional transmitter coil arranged about a concave charging platform. The three-dimensional transmitter coil includes a turn of the coil to conduct an electrical current. The three-dimensional transmitter coil also includes additional coil turns to conduct the electrical current. The coil turns are spaced at a non-uniform spacing to reduce magnetic field variations associated with the three-dimensional transmitter coil in a direction normal to a surface of the concave charging platform.

Example 2 includes the subject matter of Example 1. In this example, the coil turns include a first coil turn of the three-dimensional transmitter coil having a diameter of about 173 millimeters. The coil turns also include a second coil turn of the three-dimensional transmitter coil coupled to the first coil turn, the second coil turn having a diameter of about 164.6 millimeters.

Example 3 includes the subject matter of any combination of Examples 1-2. In this example, the coil turns include a third coil turn of the three-dimensional transmitter coil coupled to the second coil turn, the second coil turn having a diameter of about 155.2 millimeters. The coil turns also include a fourth coil turn of the three-dimensional transmitter coil coupled to the third coil turn, the fourth coil turn having a diameter of about 144.8 millimeters.

Example 4 includes the subject matter of any combination of Examples 1-3. In this example, the coil turns include a fifth coil turn of the three-dimensional transmitter coil coupled to the fourth coil turn, the fifth coil turn having a diameter of about 133.5 millimeters. The coil turns also include a sixth coil turn of the three-dimensional transmitter coil coupled to the firth coil turn, the sixth coil turn having a diameter of about 121 millimeters.

Example 5 includes the subject matter of any combination of Examples 1-4. In this example, the coil turns include seventh coil turn of the three-dimensional transmitter coil coupled to the sixth portion, the seventh coil turn having a diameter of 98 millimeters.

Example 6 includes the subject matter of any combination of Examples 1-5. In this example, the coil turns include an eighth coil turn of the three-dimensional transmitter coil coupled to the seventh coil turn, the eighth coil turn having a diameter of about 66 millimeters.

Example 7 includes the subject matter of any combination of Examples 1-6. In this example, the non-uniform spacing is based on a ratio of the dimensions of each turn. For example, the spacing discussed above in regard to Examples 1-6 may be used to determine alternate spacings between coil turns based on a ratio between coil turns in Examples 1-6.

Example 8 includes the subject matter of any combination of Examples 1-7. In this example, the concave shape is associated with a 120 degree angle of a semicircle of about 100 millimeters from a center point of the concave shape.

Example 9 includes the subject matter of any combination of Examples 1-8. In this example, the wireless charging device also includes a parasitic coil to generate a redistribution of a portion of a magnetic field associated with a driven current of the transmitting coil. The wireless charging device also includes a tuning element to tune the parasitic coil, the tuning element comprising a capacitor, wherein the redistribution is configurable based on a capacitance of the tuning element.

Example 10 includes the subject matter of any combination of Examples 1-9. In this example, the wireless charging device also includes additional parasitic coils to generate a redistribution of a portion of the magnetic field associated with the driven current of the transmitting coil. The wireless charging device also includes additional tuning elements each being coupled to a respective parasitic coil.

Example 11 is a method of forming a wireless charging device. The method includes forming a concave-shaped charging platform defining a charging area. The method also includes forming a three-dimensional transmitter coil arranged about the charging platform. The three-dimensional transmitter coil includes a turn of the coil to conduct an electrical current. The three-dimensional transmitter coil also includes additional coil turns to conduct the electrical current. The coil turns are spaced at a non-uniform spacing to reduce magnetic field variations associated with the three-dimensional transmitter coil in a direction normal to a surface of the concave charging platform.

Example 12 includes the subject matter of Example 10. In this example, the coil turns include a first coil turn of the three-dimensional transmitter coil having a diameter of about 173 millimeters. The coil turns also include a second coil turn of the three-dimensional transmitter coil coupled to the first coil turn, the second coil turn having a diameter of about 164.6 millimeters.

Example 13 includes the subject matter of any combination of Examples 11-12. In this example, the coil turns include a third coil turn of the three-dimensional transmitter coil coupled to the second coil turn, the second coil turn having a diameter of about 155.2 millimeters. The coil turns also include a fourth coil turn of the three-dimensional transmitter coil coupled to the third coil turn, the fourth coil turn having a diameter of about 144.8 millimeters.

Example 14 includes the subject matter of any combination of Examples 11-13. In this example, the coil turns include a fifth coil turn of the three-dimensional transmitter coil coupled to the fourth coil turn, the fifth coil turn having a diameter of about 133.5 millimeters. The coil turns also include a sixth coil turn of the three-dimensional transmitter coil coupled to the firth coil turn, the sixth coil turn having a diameter of about 121 millimeters.

Example 15 includes the subject matter of any combination of Examples 11-14. In this example, the coil turns include seventh coil turn of the three-dimensional transmitter coil coupled to the sixth portion, the seventh coil turn having a diameter of 98 millimeters. The coil turns include an eighth coil turn of the three-dimensional transmitter coil coupled to the seventh coil turn, the eighth coil turn having a diameter of about 66 millimeters.

Example 16 includes the subject matter of any combination of Examples 11-15. In this example, the method further includes determining a ratio of the dimensions of each turn, wherein alternate spacing between the coil turns may be formed based on the ratio.

Example 17 includes the subject matter of any combination of Examples 11-16. In this example, the method further includes identifying a coil structure having arbitrary angles of each coil turn from an axis extending through a center of the coil. The method may also include determining a magnetic field variation of coil structure, and adjusting the angles based on results of a cost function indicating optimized uniformity of the magnetic field.

Example 18 includes the subject matter of any combination of Examples 11-17. In this example, the concave shape is associated with a 120 degree angle of a semicircle of about 100 millimeters from a center point of the concave shape.

Example 19 includes the subject matter of any combination of Examples 11-18. In this example, the method further includes forming a parasitic coil to generate a redistribution of a portion of a magnetic field associated with a driven current of the transmitting coil. The method also includes forming a tuning element to tune the parasitic coil, the tuning element comprising a capacitor, wherein the redistribution is configurable based on a capacitance of the tuning element.

Example 20 includes the subject matter of any combination of Examples 11-19. In this example, the method further includes forming additional parasitic coils to generate a redistribution of a portion of the magnetic field associated with the driven current of the transmitting coil. The method also includes forming additional tuning elements each being coupled to a respective parasitic coil.

Example 21 is a wireless charging system. The wireless charging system includes a concave-shaped charging platform defining a charging area, and a three-dimensional transmitter coil arranged about a concave charging platform. The three-dimensional transmitter coil includes a turn of the coil to conduct an electrical current. The three-dimensional transmitter coil also includes additional coil turns to conduct the electrical current. The coil turns are spaced at a non-uniform spacing to reduce magnetic field variations associated with the three-dimensional transmitter coil in a direction normal to a surface of the concave charging platform.

Example 22 includes the subject matter of Example 21. In this example, the coil turns include a first coil turn of the three-dimensional transmitter coil having a diameter of about 173 millimeters. The coil turns also include a second coil turn of the three-dimensional transmitter coil coupled to the first coil turn, the second coil turn having a diameter of about 164.6 millimeters.

Example 23 includes the subject matter of any combination of Examples 21-22. In this example, the coil turns include a third coil turn of the three-dimensional transmitter coil coupled to the second coil turn, the second coil turn having a diameter of about 155.2 millimeters. The coil turns also include a fourth coil turn of the three-dimensional transmitter coil coupled to the third coil turn, the fourth coil turn having a diameter of about 144.8 millimeters.

Example 24 includes the subject matter of any combination of Examples 21-23. In this example, the coil turns include a fifth coil turn of the three-dimensional transmitter coil coupled to the fourth coil turn, the fifth coil turn having a diameter of about 133.5 millimeters. The coil turns also include a sixth coil turn of the three-dimensional transmitter coil coupled to the firth coil turn, the sixth coil turn having a diameter of about 121 millimeters.

Example 25 includes the subject matter of any combination of Examples 21-24. In this example, the coil turns include seventh coil turn of the three-dimensional transmitter coil coupled to the sixth portion, the seventh coil turn having a diameter of 98 millimeters.

Example 26 includes the subject matter of any combination of Examples 21-25. In this example, the coil turns include an eighth coil turn of the three-dimensional transmitter coil coupled to the seventh coil turn, the eighth coil turn having a diameter of about 66 millimeters.

Example 27 includes the subject matter of any combination of Examples 21-26. In this example, the non-uniform spacing is based on a ratio of the dimensions of each turn. For example, the spacing discussed above in regard to Examples 1-6 may be used to determine alternate spacings between coil turns based on a ratio between coil turns in Examples 1-6.

Example 28 includes the subject matter of any combination of Examples 21-27. In this example, the concave shape is associated with a 120 degree angle of a semicircle of about 100 millimeters from a center point of the concave shape.

Example 29 includes the subject matter of any combination of Examples 21-28. In this example, the wireless charging system also includes a parasitic coil to generate a redistribution of a portion of a magnetic field associated with a driven current of the transmitting coil. The wireless charging device also includes a tuning element to tune the parasitic coil, the tuning element comprising a capacitor, wherein the redistribution is configurable based on a capacitance of the tuning element.

Example 30 includes the subject matter of any combination of Examples 21-29. In this example, the dimensions of the non-uniform spacing are based on a ratio of the dimensions of one turn to another turn, and wherein the dimensions are scalable based on the ratio.

Example 31 is an apparatus for wireless charging. The apparatus includes a means for concave-shaped charging, the means defining a charging area. The apparatus includes a means for three-dimensional transmitter coil charging, the means arranged about the means for concave-shaped charging. The means for three-dimensional transmitter coil charging includes a turn of the coil to conduct an electrical current. The three-dimensional transmitter coil also includes additional coil turns to conduct the electrical current. The coil turns are spaced at a non-uniform spacing to reduce magnetic field variations associated with the three-dimensional transmitter coil in a direction normal to a surface of the concave charging platform.

Example 32 includes the subject matter of Example 31. In this example, the coil turns include a first coil turn of the means for three-dimensional transmitter coil charging having a diameter of about 173 millimeters. The coil turns also include a second coil turn of the three-dimensional transmitter coil coupled to the first coil turn, the second coil turn having a diameter of about 164.6 millimeters.

Example 33 includes the subject matter of any combination of Examples 31-32. In this example, the coil turns include a third coil turn of the the means for three-dimensional transmitter coil charging coupled to the second coil turn, the second coil turn having a diameter of about 155.2 millimeters. The coil turns also include a fourth coil turn of the means for three-dimensional transmitter coil charging coupled to the third coil turn, the fourth coil turn having a diameter of about 144.8 millimeters.

Example 34 includes the subject matter of any combination of Examples 31-33. In this example, the coil turns include a fifth coil turn of the means for three-dimensional transmitter coil charging coupled to the fourth coil turn, the fifth coil turn having a diameter of about 133.5 millimeters. The coil turns also include a sixth coil turn of the means for three-dimensional transmitter coil charging coupled to the firth coil turn, the sixth coil turn having a diameter of about 121 millimeters.

Example 35 includes the subject matter of any combination of Examples 31-34. In this example, the coil turns include seventh coil turn of the means for three-dimensional transmitter coil charging coupled to the sixth portion, the seventh coil turn having a diameter of 98 millimeters.

Example 36 includes the subject matter of any combination of Examples 31-35. In this example, the coil turns include an eighth coil turn of the means for three-dimensional transmitter coil charging coupled to the seventh coil turn, the eighth coil turn having a diameter of about 66 millimeters.

Example 37 includes the subject matter of any combination of Examples 31-36. In this example, the non-uniform spacing is based on a ratio of the dimensions of each turn. For example, the spacing discussed above in regard to Examples 1-6 may be used to determine alternate spacings between coil turns based on a ratio between coil turns in Examples 31-36.

Example 38 includes the subject matter of any combination of Examples 31-37. In this example, the concave shape is associated with a 120 degree angle of a semicircle of about 100 millimeters from a center point of the concave shape.

Example 39 includes the subject matter of any combination of Examples 31-38. In this example, the apparatus also includes a parasitic coil to generate a redistribution of a portion of a magnetic field associated with a driven current of the transmitting coil. The apparatus also includes a tuning element to tune the parasitic coil, the tuning element comprising a capacitor, wherein the redistribution is configurable based on a capacitance of the tuning element.

Example 40 includes the subject matter of any combination of Examples 31-39. In this example, the dimensions of the non-uniform spacing are based on a ratio of the dimensions of one turn to another turn, and wherein the dimensions are scalable based on the ratio.

Example 41 is a wireless charging system. The apparatus includes a means for forming a concave-shaped charging platform defining a charging area, and a means for forming a three-dimensional transmitter coil arranged about a concave charging platform. The three-dimensional transmitter coil includes a turn of the coil to conduct an electrical current. The three-dimensional transmitter coil also includes additional coil turns to conduct the electrical current. The coil turns are spaced at a non-uniform spacing to reduce magnetic field variations associated with the three-dimensional transmitter coil in a direction normal to a surface of the concave charging platform.

Example 42 includes the subject matter of Example 41. In this example, the coil turns include a first coil turn of the three-dimensional transmitter coil having a diameter of about 173 millimeters. The coil turns also include a second coil turn of the three-dimensional transmitter coil coupled to the first coil turn, the second coil turn having a diameter of about 164.6 millimeters.

Example 43 includes the subject matter of any combination of Examples 41-42. In this example, the coil turns include a third coil turn of the three-dimensional transmitter coil coupled to the second coil turn, the second coil turn having a diameter of about 155.2 millimeters. The coil turns also include a fourth coil turn of the three-dimensional transmitter coil coupled to the third coil turn, the fourth coil turn having a diameter of about 144.8 millimeters.

Example 44 includes the subject matter of any combination of Examples 41-43. In this example, the coil turns include a fifth coil turn of the three-dimensional transmitter coil coupled to the fourth coil turn, the fifth coil turn having a diameter of about 133.5 millimeters. The coil turns also include a sixth coil turn of the three-dimensional transmitter coil coupled to the firth coil turn, the sixth coil turn having a diameter of about 121 millimeters.

Example 45 includes the subject matter of any combination of Examples 41-44. In this example, the coil turns include seventh coil turn of the three-dimensional transmitter coil coupled to the sixth portion, the seventh coil turn having a diameter of 98 millimeters. The coil turns include an eighth coil turn of the three-dimensional transmitter coil coupled to the seventh coil turn, the eighth coil turn having a diameter of about 66 millimeters.

Example 46 includes the subject matter of any combination of Examples 41-45. In this example, the apparatus includes a means for determining a ratio of the dimensions of each turn, wherein alternate spacing between the coil turns may be formed based on the ratio.

Example 47 includes the subject matter of any combination of Examples 41-46. In this example, the apparatus includes a means for identifying a coil structure having arbitrary angles of each coil turn from an axis extending through a center of the coil. The apparatus also includes a means for determining a magnetic field variation of coil structure, and a means for adjusting the angles based on results of a cost function indicating optimized uniformity of the magnetic field. The means recited herein may include a computer-readable medium, such as a non-transitory computer-readable medium having instructions thereon that may carry out the operations of Example 47.

Example 48 includes the subject matter of any combination of Examples 41-47. In this example, the concave shape is associated with a 120 degree angle of a semicircle of about 100 millimeters from a center point of the concave shape.

Example 49 includes the subject matter of any combination of Examples 41-48. In this example, the apparatus includes also includes a means for forming a parasitic coil to generate a redistribution of a portion of a magnetic field associated with a driven current of the transmitting coil. The apparatus also includes a means for forming a tuning element to tune the parasitic coil, the tuning element comprising a capacitor, wherein the redistribution is configurable based on a capacitance of the tuning element.

Example 50 includes the subject matter of any combination of Examples 41-49. In this example, the apparatus includes a means for forming additional parasitic coils to generate a redistribution of a portion of the magnetic field associated with the driven current of the transmitting coil. The apparatus may also include a means for forming additional tuning elements each being coupled to a respective parasitic coil.

Aspects are applicable for use with all types of battery powered devices, such as, for example, a smart phone, mobile Internet device (MID), smart tablet, convertible tablet, notebook computer, or other similar portable device. The term “coupled” or “connected” may be used herein to refer to any type of relationship, direct or indirect, between the components in question, and may apply to electrical, mechanical, fluid, optical, electromagnetic, electromechanical or other connections. In addition, the terms “first,” “second,” and the like, are used herein only to facilitate discussion, and carry no particular temporal or chronological significance unless otherwise indicated.

Those skilled in the art will appreciate from the foregoing description that the broad techniques of the aspects can be implemented in a variety of forms. Therefore, while the aspects have been described in connection with particular examples thereof, the true scope of the aspects should not be so limited since other modifications will become apparent to the skilled practitioner upon a study of the drawings, specification, and following claims.

1. A wireless charging device, comprising:
a charging physical platform defining a charging region for charging devices of varying shape and size placed within the charging region; and
a three-dimensional transmitter coil arranged inside the charging physical platform, the three-dimensional transmitter coil comprising a plurality of coil turns configured to carry an electrical current and to generate a corresponding magnetic field, the plurality of coil turns having a non-uniform spacing,
wherein the non-uniform spacing of the plurality of coil turns increases a uniformity of distribution of a normal component of the magnetic field generated within the charging region, and
wherein the normal component of the magnetic field generated by the three-dimensional transmitter coil is directly received by the devices in free space within the charging region and used to charge the devices.

2. The wireless charging device of claim 1, wherein the devices of varying shape and size include at least one mobile phone.

3. The wireless charging device of claim 1, further comprising:
a parasitic coil including at least one coil turn that is disposed between at least two of the plurality of coil turns of the three-dimensional transmitter coil.

4. The wireless charging device of claim 3, wherein the parasitic coil is configured to redistribute a portion of the magnetic field associated with the three-dimensional transmitter coil.

5. The wireless charging device of claim 3, further comprising:
a tuning element configured to tune the parasitic coil,
wherein the redistributed portion of the magnetic field associated with the three-dimensional transmitter coil is based upon a capacitance of the tuning element.

6. The wireless charging device of claim 3, wherein the parasitic coil is configured to redistribute a portion of the magnetic field associated with the three-dimensional transmitter coil by carrying an electrical current in an opposite direction with respect to a direction of the electrical current propagating through the plurality of coil turns of the three-dimensional transmitter coil.

7. The wireless charging device of claim 1, wherein the three-dimensional transmitter coil comprises a continuous spiral structure.

8. A charging station, comprising:
a charging physical platform defining a charging region for charging devices of varying shape and size placed within the charging region; and
a three-dimensional transmitter coil arranged inside the charging physical platform, the three-dimensional transmitter coil comprising a plurality of coil turns configured to carry an electrical current and to generate a corresponding magnetic field, the plurality of coil turns having a non-uniform spacing,
wherein the non-uniform spacing of the plurality of coil turns increases a uniformity of distribution of a normal component of the magnetic field generated within the charging region, and
wherein the normal component of the magnetic field generated by the three-dimensional transmitter coil is directly received by the devices in free space within the charging region and used to charge the devices.

9. The charging station of claim 8, wherein the devices of varying shape and size include at least one mobile phone.

10. The charging station of claim 8, further comprising:
a parasitic coil including at least one coil turn that is disposed between at least two of the plurality of coil turns of the three-dimensional transmitter coil.

11. The charging station of claim 10, wherein the parasitic coil is configured to redistribute a portion of the magnetic field associated with the three-dimensional transmitter coil.

12. The charging station of claim 10, further comprising:
a tuning element configured to tune the parasitic coil,
wherein the redistributed portion of the magnetic field associated with the three-dimensional transmitter coil is based upon a capacitance of the tuning element.

13. The charging station of claim 10, wherein the parasitic coil is configured to redistribute a portion of the magnetic field associated with the three-dimensional transmitter coil by carrying an electrical current in an opposite direction with respect to a direction of the electrical current propagating through the plurality of coil turns of the three-dimensional transmitter coil.

14. The charging station of claim 8, wherein the three-dimensional transmitter coil comprises a continuous spiral structure.

15. A wireless charging system, comprising:
a charging physical platform defining a charging space for charging devices of varying shape and size;
a three-dimensional transmitter coil arranged inside the charging physical platform, the three-dimensional transmitter coil including a plurality of coil turns configured to carry an electrical current to generate a corresponding magnetic field, the plurality of coil turns having a non-uniform spacing; and
a parasitic coil disposed between at least two of the plurality of coil turns of three-dimensional transmitter coil, the parasitic coil being configured to redistribute a portion of the magnetic field associated with the three-dimensional transmitter coil,
wherein the non-uniform spacing and the parasitic coil control a variation of the magnetic field associated with the three-dimensional transmitter coil in a direction normal to a surface of the physical charging platform.

16. The wireless charging system of claim 15, wherein the devices of varying shape and size include at least one mobile phone.

17. The wireless charging system of claim 15, further comprising:
a tuning element configured to tune the parasitic coil,
wherein the redistributed portion of the magnetic field associated with the three-dimensional transmitter coil is based upon a capacitance of the tuning element.

18. The wireless charging system of claim 17, wherein tuning the capacitance of the tuning element to a lower capacitance results in a larger redistribution of the magnetic field compared to tuning the capacitance of the tuning element to a higher capacitance.

19. The wireless charging system of claim 15, wherein the parasitic coil is configured to redistribute a portion of the magnetic field associated with the three-dimensional transmitter coil by carrying an electrical current in an opposite direction with respect to a direction of the electrical current propagating through the plurality of coil turns of the three-dimensional transmitter coil.

20. The wireless charging system of claim 15, wherein the three-dimensional transmitter coil comprises a continuous spiral structure.
